(19) United States
(12) Patent Application Publication
(10) Pub. No.: US 2019/0293601 A1
(43) Pub. Date: Sep. 26, 2019

(54) PARTICULATE DETECTION APPARATUS

(71) Applicant: NGK SPARK PLUG CO., LTD., Nagoya-shi (JP)

(72) Inventor: Takeshi SUGIYAMA, Nagoya (JP)

(73) Assignee: NGK SPARK PLUG CO., LTD., Nagoya-shi (JP)

(21) Appl. No.: 16/357,467

(22) Filed: Mar. 19, 2019

(30) Foreign Application Priority Data
Mar. 23, 2018 (JP) 2018-056408

(51) Int. Cl. G01N 27/62

(52) U.S. Cl. CPC G01N 27/62

(57) ABSTRACT

A particulate detection apparatus for controlling a particulate sensor detecting an amount of particulates in exhaust gas and including a calculation section, cumulating section, and anomaly determination section. The calculation section is configured to calculate, every time a previously set unit measurement time elapses, the value of a signal current or converted value representing the amount of electrified particulates. The cumulating section is configured to cumulate the value of the signal current or converted value thereof to thereby calculate a cumulative value. The anomaly determination section is configured to determine whether or not an amount of change in the cumulative value in a unit cumulating time set to be longer than the unit measurement time is greater than a previously set anomaly determination value, and to determine that the detection performance of the detection section is anomalous when the amount of change is greater than the anomaly determination value.

### BACKGROUND OF THE DISCLOSURE

### 1. Field of the Disclosure

The present disclosure relates to a particulate detection apparatus for detecting an amount of particulates contained in exhaust gas.

### 2. Description of the Related Art

Patent Document 1 discloses a particulate detection apparatus which detects the amount of particulates contained in exhaust gas within an exhaust pipe using a particulate sensor. The particulate sensor includes a first potential member maintained at a first potential, a second potential member maintained at a second potential, and an insulating member for insulating these potential members from each other. The particulate detection apparatus disclosed in Patent Document 1 checks the quality of the insulation between the first potential member and the second potential member when the particulate sensor is initially driven (i.e., put into operation), or when re-checked at timing intervals in a period during which the particulate sensor is driven. Further, the particulate detection apparatus determines whether or not to drive the particulate sensor based on the quality of the insulation.

[Patent Document 1] Japanese Patent Application Laid-Open (kokai) No. 2013-195069

### 3. Problems to be Solved by the Invention

If condensed water produced in the exhaust pipe when the particulate sensor is driven flows inside the exhaust pipe and adheres to the above-mentioned insulating member of the particulate sensor, the quality of the insulation is temporarily reduced until the adhered condensed water evaporates. As a results, the detection performance of the particulate sensor is temporarily lowered as well. Since the particulate detection apparatus disclosed in Patent Document 1 checks the quality of the insulation when the particulate sensor is initially driven or when re-checked at timing intervals during operation, the particulate detection apparatus may fail to detect such temporary deterioration in the detection performance of the particulate sensor.

### SUMMARY OF THE INVENTION

It is therefore an object of the present disclosure to detect a temporary deterioration in the detection performance of a particulate sensor.

The above object of the present disclosure has been achieved by providing (1) a particulate detection apparatus for controlling a particulate sensor which is attached to an exhaust pipe of an internal combustion engine and which detects an amount of particulates contained in exhaust gas within the exhaust pipe. The particulate sensor includes a detection section and an insulating member. The detection section is configured to electrify particulates contained in the exhaust gas flowing into an internal space of the detection section, thereby generating electrified particulates. The insulating member has a gas contact surface which comes into contact with the exhaust gas. The insulating member is configured such that the detection performance of the detection section deteriorates when particulates adhere to the gas contact surface.

The particulate detection apparatus includes a calculation section, a cumulating section, and an anomaly determination section. The calculation section is configured to calculate, every time a previously set unit measurement time elapses, the value of a signal current flowing due to the electrified particulates or a converted value which is obtained from the signal current and which represents the amount of the particulates. The cumulating section is configured to cumulate the value of the signal current or converted value thereof to thereby calculate a cumulative value. The anomaly determination section is configured to determine whether or not an amount of change in the cumulative value in a unit cumulating time set to be longer than the unit measurement time is greater than a previously set anomaly determination value and to determine that the detection performance of the detection section is anomalous when the amount of change is greater than the anomaly determination value.

In the case where condensed water generated within the exhaust pipe flows inside the exhaust pipe and adheres to the insulating member of the particulate sensor, thereby lowering the quality of the insulation of the insulating member, the particulate detection apparatus of the present disclosure configured as described above can determine that the detection performance of the detection section is anomalous for the following reason. In the case where the quality of the insulation of the insulating member is lowered as a result of adhesion of the condensed water, the signal current becomes larger, as compared with the case where the quality of the insulation of the insulating member is not lowered, and the change amount of the cumulative value in the unit cumulating time becomes greater than the anomaly determination value. Thus, the particulate detection apparatus of the present disclosure can detect a temporary deterioration in the detection performance of the particulate sensor.

In a preferred embodiment (2) of the particulate detection apparatus (1), the anomaly determination section is configured such that, every time the unit cumulating time elapses, the anomaly determination section determines whether or not an updated amount of change in the unit cumulating time is greater than the anomaly determination value.

In another preferred embodiment (3) of the particulate detection apparatus, the anomaly determination section is configured such that, after the unit cumulating time has elapsed for the first time after the cumulating section had started the calculation of the cumulative value, every time the unit measurement time elapses, the anomaly determination section updates the unit cumulating time, and determines whether or not the amount of change in the updated unit cumulating time is greater than the anomaly determination value.

In the case where the above determination is made every time the unit cumulating time elapses, the computation load for determining whether or not the detection performance of the detection section is anomalous can be reduced as compared with the case where the above determination is made every time the unit measurement time elapses. Meanwhile, in the case where the above determination is made every time the unit measurement time has elapsed, an anomaly of the detection performance of the detection section can be detected earlier as compared with the case where the above determination is made every time the unit cumulating time has elapsed.

In yet another preferred embodiment (4) of the detection apparatus of any one of (1) to (3) above, the particulate sensor includes an inner metallic member and an outer metallic member and the insulating member is disposed between the inner metallic member and the outer metallic member so as to electrically insulate the inner metallic member and the outer metallic member from each other. The inner metallic member has a gas introduction pipe for introducing exhaust gas into an internal space of the inner metallic member, is maintained at a potential different from that of the exhaust pipe, and is contained in the detection section. The outer metallic member surrounds the circumference of the inner metallic member and is attached to the exhaust pipe so as to be electrically connected to the exhaust pipe.

In the case where condensed water adheres to the gas contact surface of the insulating member disposed between the inner metallic member and the outer metallic member, thereby lowering the insulating performance of the insulating member between the inner metallic member and the outer metallic member, the particulate detection apparatus of the present disclosure configured as described above can determine that the detection performance of the detection section is anomalous. Thus, the particulate detection apparatus of the present disclosure can detect a temporary deterioration of the detection performance of the particulate sensor.

### BRIEF DESCRIPTION OF THE DRAWINGS

FIG. 1 is a diagram schematically showing the configuration of a system which includes a sensor control apparatus as a constituent element.

FIG. 2 is a sectional view of a particulate sensor.

FIG. 3 is an exploded perspective view of the particulate sensor.

FIG. 4 is a perspective view of an insulating spacer from a forward end side.

FIG. 5 is a perspective view of the insulating spacer from a back end side.

FIG. 6 is a perspective view of a ceramic element.

FIG. 7 is an exploded perspective view of the ceramic element.

FIG. 8 is a diagram showing the circuit configuration of the sensor control apparatus.

FIG. 9 is a schematic view used for describing the detection operation of the particulate sensor.

FIG. 10 is a flowchart showing a sensor output obtaining process.

FIG. 11 is a flowchart showing an anomaly detection process of a first embodiment.

FIG. 12 are graphs showing time-course change in the value of current detected by a current detection circuit and time-course change in cumulative value.

FIG. 13 is a flowchart showing an anomaly detection process of a second embodiment.

### DESCRIPTION OF REFERENCE NUMERALS

Reference numerals used to identify various features in the drawings include the following.

1 . . . sensor control apparatus; 2 . . . particulate sensor; 3 . . . diesel engine; 6 . . . exhaust pipe; 12 . . . ceramic element; 21 . . . inner metallic member; 23 . . . insulating spacer; 23a . . . gas contact surface

### DETAILED DESCRIPTION OF THE PREFERRED EMBODIMENTS

Various embodiments of the present disclosure will now be described in greater detail with reference to the drawings. However, the present disclosure should not be construed as being limited thereto.

### First Embodiment

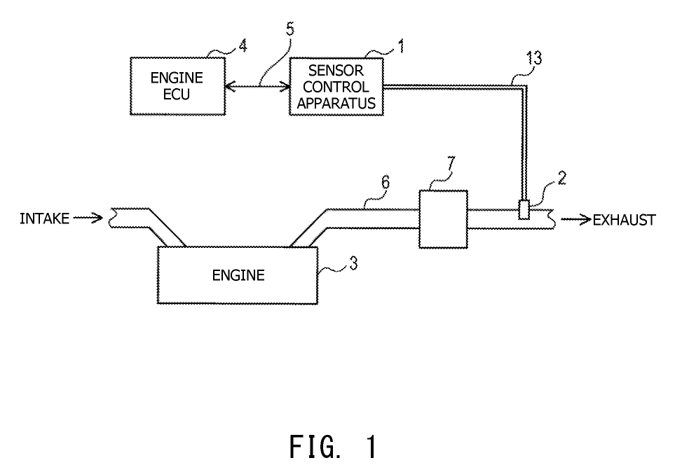

A sensor control apparatus 1 of the present embodiment is mounted on a vehicle and controls a particulate sensor 2 as shown in FIG. 1.

The sensor control apparatus 1 is configured such that data can be transmitted to and received from an electronic control apparatus 4, which controls a diesel engine 3, through a communication line 5. Hereinafter, the electronic control apparatus 4 will be referred to as an engine ECU 4. ECU is an abbreviation for Electronic Control Unit.

A DPF 7 is disposed in an exhaust pipe 6 of the diesel engine 3. The DPF 7 takes in exhaust gas and removes particulate matter contained in the exhaust gas. DPF is an abbreviation for Diesel Particulate Filter.

A particulate sensor 2 is disposed in the exhaust pipe 6 to be located on the downstream side of the DPF 7 and detects the amount of particulates (e.g., soot) contained in the exhaust gas discharged from the DPF 7.

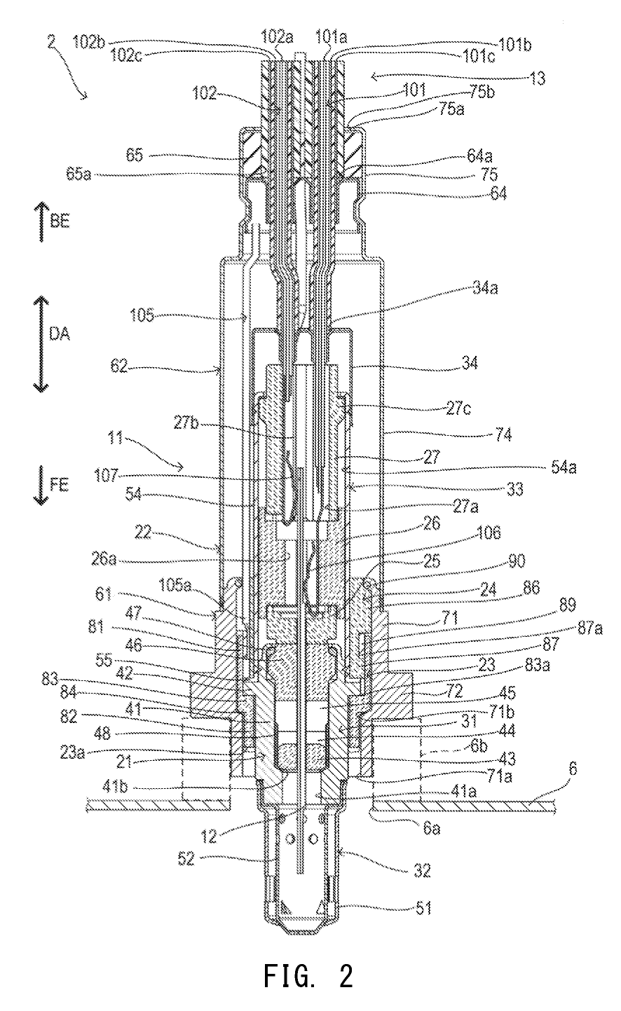

As shown in FIG. 2, the particulate sensor 2 includes a casing 11, a ceramic element 12, and cables 13. In FIG. 2, the lower end side of the particulate sensor 2 is defined as the forward end side FE, the upper end side of the particulate sensor 2 is defined as the back end side BE, and the longitudinal direction of the particulate sensor 2 is defined as the axial direction DA.

The casing 11 holds the ceramic element 12 in such a manner that a portion of the ceramic element 12 on the forward end side FE protrudes into the exhaust pipe 6.

The casing 11 includes an inner metallic member 21, an outer metallic member 22, insulating spacers 23 and 24, an insulating holder 25, and separators 26 and 27.

The inner metallic member 21 includes a metallic shell 31, a gas introduction pipe 32, an inner tube 33, and an inner tube connection metallic member 34.

The metallic shell 31 is a tubular member formed of stainless steel extending in the axial direction DA. The metallic shell 31 has a main body 41 and a flange portion 42. The main body 41 has a cylindrical shape and extends in the axial direction DA. The main body 41 has a through hole 41a which extends therethrough in the axial direction DA and a ledge portion 41b which protrudes toward a radially inner region of the through hole 41a. The ledge portion 41b has an inward taper surface tapered such that the diameter of the taper surface decreases toward the forward end side FE. The flange portion 42 has the shape of a plate extending radially outward from the peripheral surface of the main body 41.

A tubular ceramic holder 43 surrounding the circumference of the ceramic element 12, talc rings (layers formed by charging talc powder) 44 and 45, and a ceramic sleeve 46 are stacked in the through hole 41a of the metallic shell 31 in this order from the forward end side FE toward the back end side BE.

A crimp ring 47 is disposed between the ceramic sleeve 46 and an end portion of the metallic shell 31 on the back end side BE. A metal holder 48 is disposed between the ceramic holder 43 and the ledge portion 41b of the metallic shell 31. The metal holder 48 holds the talc ring 44 and the ceramic holder 43. The end portion of the metallic shell 31 on the back end side BE is a portion which is crimped so as to press the ceramic sleeve 46 toward the forward end side FE via the crimp ring 47.

The gas introduction pipe 32 is provided at an end portion of the metallic shell 31 on the forward end side FE and includes an outer protector 51 and an inner protector 52. Each of the outer protector 51 and the inner protector 52 is a tubular member formed of stainless steel extending in the axial direction DA. The inner protector 52 is welded to the metallic shell 31 in a state in which the inner protector 52 covers an end portion of the ceramic element 12 on the forward end side FE. The outer protector 51 is welded to the metallic shell 31 in a state in which the outer protector 51 covers the inner protector 52.

The inner tube 33 is a cylindrical member formed of stainless steel extending in the axial direction DA. The inner tube 33 has a main body 54 and a flange portion 55. The main body 54 has a cylindrical shape, extends in the axial direction DA, and has a through hole 54a extending therethrough in the axial direction DA. The flange portion 55 is provided at the end portion of the main body 54 on the forward end side FE and has the shape of a plate extending radially outward from the periphery of the end portion. The inner tube 33 is welded to the metallic shell 31 in a state in which an end portion of the metallic shell 31 on the back end side BE is fitted into an opening of an end portion of the inner tube 33 on the forward end side FE; i.e., in a state in which the flange portion 55 is placed on the flange portion 42 of the metallic shell 31.

An insulating holder 25, a separator 26, and a separator 27 are stacked in the through hole 54a of the inner tube 33 in this order from the forward end side FE toward the back end side BE.

The insulating holder 25 is a tubular insulative member which surrounds the circumference of the ceramic element 12.

The separator 26 is a cylindrical insulative member extending in the axial direction DA. The separator 26 has a through hole 26a extending therethrough in the axial direction DA. The ceramic element 12 is inserted into the through hole 26a such that the ceramic element 12 protrudes from an end portion of the separator 26 on the back end side BE.

The separator 27 is a cylindrical insulative member extending in the axial direction DA. An end portion of the ceramic element 12 on the back end side BE is inserted into the interior of the separator 27. The separator 27 has a through hole 27a and a through hole 27b which extend therethrough in the axial direction DA. The separator 27 has a flange portion 27c which protrudes radially outward from its outer surface.

An end portion of the inner tube 33 on the back end side BE is crimped so as to press the flange portion 27c toward the forward end side FE. As a result, the insulating holder 25, the separator 26, and the separator 27 are fixedly held by the inner tube 33.

The inner tube connection metallic member 34 is a tubular member formed of stainless steel and closed at its end on the back end side BE. The inner tube connection metallic member 34 is welded to the inner tube 33 in a state in which an end portion of the inner tube 33 on the back end side BE is fitted into an opening of an end portion of the inner tube connection metallic member 34 on the forward end side FE. The inner tube connection metallic member 34 has a plurality of insertion openings 34a which are formed in its end portion on the back end side BE and into which the cables 13 are inserted.

The outer metallic member 22 includes a metallic attachment member 61 and an outer tube 62. The metallic attachment member 61 is a cylindrical member formed of stainless steel extending in the axial direction DA. The metallic attachment member 61 has a main body 71 and a hexagonal portion 72. The main body 71 has a cylindrical shape, extends in the axial direction DA, and has a through hole 71a extending therethrough in the axial direction DA and a ledge portion 71b protruding toward a radially inner region of the through hole 71a. The ledge portion 71b has an inward taper surface tapered such that the diameter of the taper surface decreases toward the forward end side FE. The main body 71 has an external thread which is formed on the periphery of its portion on the forward end side FE for fixing to the exhaust pipe 6. The hexagonal portion 72 extends radially outward from the periphery of a portion of the main body 71 on the back end side BE and has the shape of a plate having a hexagonal periphery.

The exhaust pipe 6 has an insertion opening 6a into which the particulate sensor 2 is inserted. An attachment boss 6b is attached to the outer circumferential surface of the exhaust pipe 6 in such a manner that the attachment boss 6b surrounds the insertion opening 6a. Therefore, by an operation of inserting the particulate sensor 2 into a screw hole of the attachment boss 6b and bringing the external thread of the metallic attachment member 61 into screw engagement with an internal thread formed on the inner circumferential wall of the screw hole of the attachment boss 6b, the particulate sensor 2 is attached to the exhaust pipe 6 such that the gas introduction pipe 32 protrudes from the inner circumferential surface of the exhaust pipe 6.

The outer tube 62 is a cylindrical member formed of stainless steel extending in the axial direction DA. The outer tube 62 has a large diameter portion 74 and a small diameter portion 75. The large diameter portion 74, which has a cylindrical shape and extends in the axial direction DA, is welded to the metallic attachment member 61 in a state in which an end portion of the metallic attachment member 61 on the back end side BE is fitted into an opening of an end portion of the large diameter portion 74 on the forward end side FE.

The small diameter portion 75, which has a cylindrical shape and extends in the axial direction DA, has an outer diameter and an inner diameter smaller than those of the large diameter portion 74. The small diameter portion 75 protrudes in the axial direction DA from an end portion of the large diameter portion 74 on the back end side BE. The small diameter portion 75 has a diameter reducing portion 75a which extends radially inward from its end on the back end side BE. The diameter reducing portion 75a has an insertion opening 75b which is formed in a central region thereof and into which the cables 13 are inserted.

The inner tube 33 and the inner tube connection metallic member 34 are accommodated in the large diameter portion 74. An outer tube connection metallic member 64 and a grommet 65 are accommodated in the small diameter portion 75 in a state in which the outer tube connection metallic member 64 and the grommet 65 are stacked in this order from the forward end side FE toward the back end side BE.

The outer tube connection metallic member 64 is a tubular member formed of stainless steel and closed at its end on the back end side BE. The outer tube connection metallic member 64 has a plurality of insertion openings 64a which are formed in its end portion on the back end side BE and into which the cables 13 are inserted.

The grommet 65 is a circular columnar member formed of heat-resisting rubber extending in the axial direction DA. The grommet 65 has a plurality of insertion openings 65a into which the cables 13 are inserted.

The grommet 65 is accommodated in the small diameter portion 75 with its outer circumferential surface being pressed against an inner circumferential surface of the small diameter portion 75. The small diameter portion 75 is crimped radially inward, whereby the outer tube connection metallic member 64 and the small diameter portion 75 are fixed together for integration. As a result, the grommet 65 is fixed inside the small diameter portion 75 in a state in which the grommet 65 closes the insertion opening 75b of the small diameter portion 75.

The insulating spacer 23 is a cylindrical member formed of alumina and extending in the axial direction DA. The insulating spacer 23 has a large diameter portion 81, a small diameter portion 82, a step portion 83, and a sloping portion 84.

The large diameter portion 81 has the shape of a cylinder extending in the axial direction DA. The small diameter portion 82, which also has the shape of a cylinder extending in the axial direction DA, is smaller in outer and inner diameters than the large diameter portion 81 and is disposed on the forward end side FE of the large diameter portion 81.

The step portion 83, which also has the shape of a cylinder extending in the axial direction DA, has an outer diameter equal to that of the large diameter portion 81 and an inner diameter equal to that of the small diameter portion 82. The step portion 83 protrudes in the axial direction DA from an end portion of the large diameter portion 81 on the forward end side FE. As a result, a step 83a protruding radially inward is formed at a location where the large diameter portion 81 is connected to the step portion 83.

The sloping portion 84 is disposed between the step portion 83 and the small diameter portion 82. The sloping portion 84 has the shape of a cylinder whose inner diameter is equal to that of the small diameter portion 82. The sloping portion 84 is tapered such that its outer diameter decreases gradually from a location where the sloping portion 84 is connected to the step portion 83 toward a location where the sloping portion 84 is connected to the small diameter portion 82.

The insulating spacer 23 is accommodated in the through hole 71a of the metallic attachment member 61 in a state in which an outer circumferential surface of the sloping portion 84 is in contact with the ledge portion 71b of the metallic attachment member 61. Since the insulating spacer 23 is accommodated in the metallic attachment member 61 as described above, the insulating spacer 23 has a gas contact surface 23a at its end portion on the forward end side FE. The gas contact surface 23a comes into contact with the exhaust gas.

The metallic shell 31 is accommodated in the insulating spacer 23 in a state in which the flange portion 42 is supported by the step 83a of the insulating spacer 23. As a result, the metallic shell 31 is accommodated in the metallic attachment member 61 in a state in which the metallic shell 31 is electrically insulated from the metallic attachment member 61.

The insulating spacer 24 is a cylindrical member formed of alumina extending in the axial direction DA. The insulating spacer 24 has a large diameter portion 86 and a small diameter portion 87.

The large diameter portion 86 has the shape of a cylinder extending in the axial direction DA. The small diameter portion 87, which also has the shape of a cylinder extending in the axial direction DA, has an outer diameter smaller than that of the large diameter portion 86 and an inner diameter equal to that of the large diameter portion 86. The small diameter portion 87 protrudes in the axial direction DA from an end portion of the large diameter portion 86 on the forward end side FE. The small diameter portion 87 has a groove 87a which is formed on its outer circumferential surface to extend in the circumferential direction. A cylindrical heater connection metallic member 89 is disposed in the groove 87a.

The insulating spacer 24 is disposed on the back end side BE of the insulating spacer 23 as a result of insertion of the small diameter portion 87 into the internal space of the large diameter portion 81 of the insulating spacer 23. Thus, the inner tube 33 and the metallic attachment member 61 are electrically insulated from each other. A wire packing 90 is disposed between the large diameter portion 86 of the insulating spacer 24 and an end portion of the metallic attachment member 61 on the back end side BE. The end portion of the metallic attachment member 61 on the back end side BE is crimped so as to press the insulating spacer 24 toward the forward end side FE via the wire packing 90. As a result, the insulating spacers 23 and 24 are fixed inside the metallic attachment member 61.

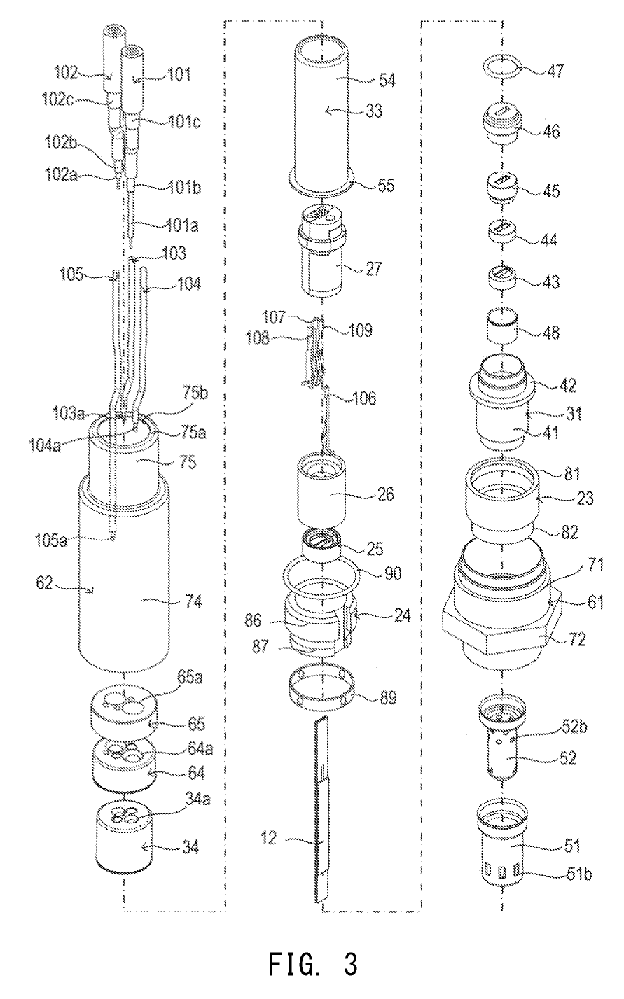

As shown in FIG. 3, the cables 13 include electric wires 101, 102, 103, 104, and 105. The electric wire 101 is a triaxial cable and includes a lead wire 101a, an inside outer conductor 101b, and an outside outer conductor 101c. The inside outer conductor 101b surrounds the circumference of the lead wire 101a. The outside outer conductor 101c surrounds the circumference of the inside outer conductor 101b. The electric wire 102 is a triaxial cable and includes a lead wire 102a, an inside outer conductor 102b, and an outside outer conductor 102c. The inside outer conductor 102b surrounds the circumference of the lead wire 102a. The outside outer conductor 102c surrounds the circumference of the inside outer conductor 102b. The electric wires 103, 104, and 105 are single core insulated wires and include lead wires 103a, 104a, and 105a, respectively.

Respective end portions of the lead wires 101a, 102a, 103a, and 104a on the forward end side FE are connected to metallic terminals 106, 107, 108, and 109, respectively. The lead wires 101a, 102a, 103a, and 104a are inserted into the inner tube 33. The metallic terminal 106 is disposed in the separator 26. The metallic terminals 107, 108, and 109 are disposed in the separator 27.

As shown in FIG. 2, the lead wire 105a is inserted into the outer tube 62. An end portion of the lead wire 105a on the forward end side FE is connected to the heater connection metallic member 89. The inside outer conductors 101b and 102b are in contact with the inner tube connection metallic member 34 inside the insertion openings 34a of the inner tube connection metallic member 34, so that the inside outer conductors 101b and 102b are electrically connected to the inner metallic member 21. The outside outer conductors 101c and 102c are in contact with the outer tube connection metallic member 64 inside the insertion openings 64a of the outer tube connection metallic member 64, so that the outside outer conductors 101c and 102c are electrically connected to the outer metallic member 22.

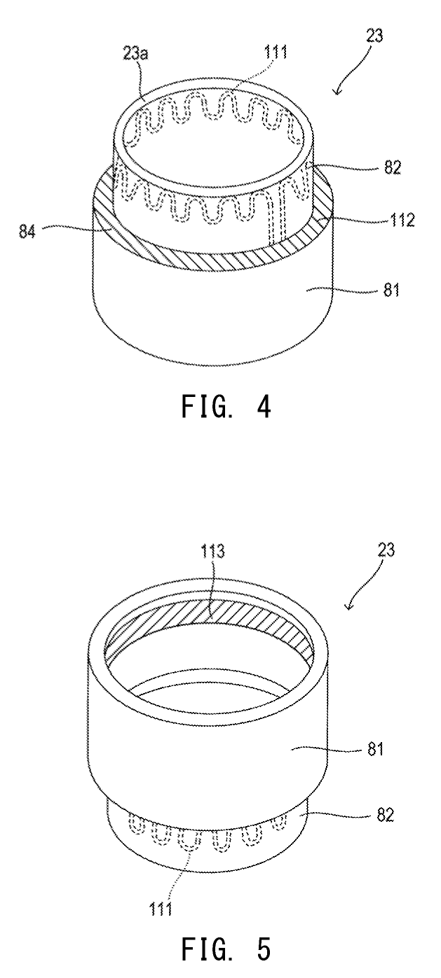

As shown in FIG. 4, the insulating spacer 23 includes a heat generation resistor 111. The heat generation resistor 111, which has a wire-like shape, is embedded in the small diameter portion 82 in such a manner that the heat generation resistor 111 meanderingly extends over the entire circumference of the small diameter portion 82. The insulating spacer 23 has a heater terminal 112. The heater terminal 112 is formed over the entire outer circumferential surface of the sloping portion 84. One end of the heat generation resistor 111 is connected to the heater terminal 112.

As shown in FIG. 5, the insulating spacer 23 has a heater terminal 113. The heater terminal 113 is formed on the inner circumferential surface of the large diameter portion 81 in such a manner as to have an annular shape; i.e., extending in the circumferential direction of the large diameter portion 81. The other end of the heat generation resistor 111 is connected to the heater terminal 113. In a state in which the insulating spacer 23 and the insulating spacer 24 are fixedly disposed in the metallic attachment member 61, the heater connection metallic member 89 disposed in the groove 87a of the insulating spacer 24 is in contact with the heater terminal 113 of the insulating spacer 23.

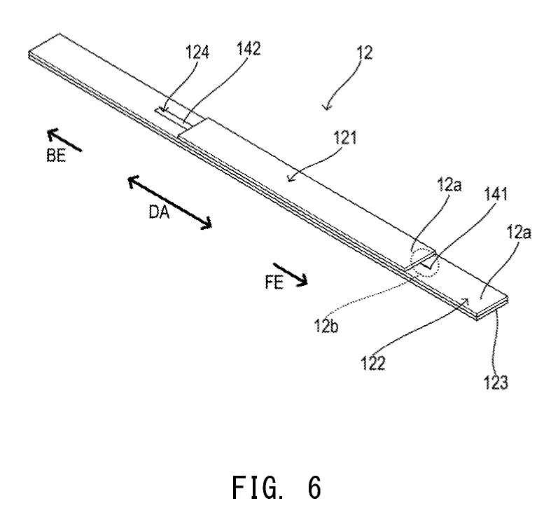

As shown in FIG. 6, the ceramic element 12 is formed by successively stacking ceramic layers 121, 122, and 123 so that the ceramic element 12 has the shape of a plate extending in the axial direction DA. The ceramic element 12 includes a discharge electrode member 124 interposed between the ceramic layer 121 and the ceramic layer 122.

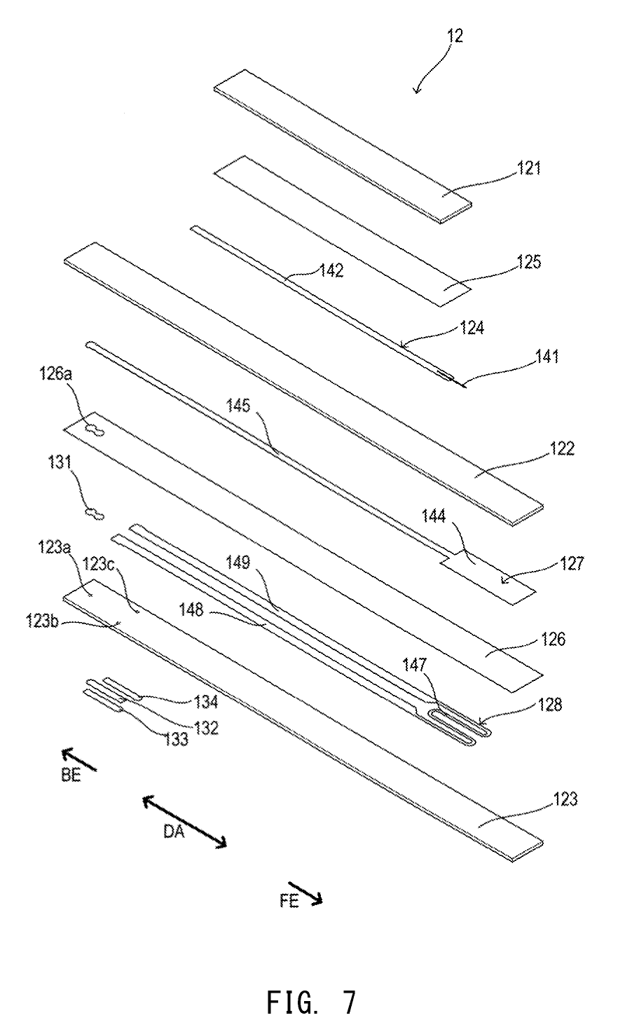

As shown in FIG. 7, each of the ceramic layers 121, 122, and 123 is a plate-shaped member formed of alumina extending in the axial direction DA. The length of the ceramic layer 121 measured in the axial direction DA is smaller than those of the ceramic layers 122 and 123. The length of the ceramic layer 122 measured in the axial direction DA is equal to that of the ceramic layer 123.

The discharge electrode member 124 has a needle-shaped electrode portion 141 and a lead portion 142. The needle-shaped electrode portion 141 is a needle-shaped member formed of platinum and extending in the axial direction DA. The lead portion 142 is an elongated member formed of tungsten extending in the axial direction DA. The lead portion 142 is formed by pattern printing. An end portion of the needle-shaped electrode portion 141 on the back end side BE is connected to an end portion of the lead portion 142 on the forward end side FE.

The ceramic element 12 has insulating cover layers 125 and 126, an auxiliary electrode member 127, and an element heater 128.

The insulating cover layer 125 is an alumina-made member which is formed by printing to have the same rectangular shape as the ceramic layer 121. The insulating cover layer 126 is an alumina-made member which is formed by printing to have the same rectangular shape as the ceramic layers 122 and 123.

The auxiliary electrode member 127 is a thin-film-shaped electrode which is formed by pattern printing and extends in the axial direction DA. The auxiliary electrode member 127 has a rectangular auxiliary electrode portion 144 and an elongated lead portion 145 extending in the axial direction DA. An end portion of the auxiliary electrode portion 144 on the back end side BE is connected to an end portion of the lead portion 145 on the forward end side FE.

The element heater 128 is formed by pattern printing a platinum paste which contains platinum as a main component and also contains ceramic. The element heater 128 has a heat generation resistor 147 and lead portions 148 and 149. The lead portion 148 is connected to one end of the heat generation resistor 147, and the lead portion 149 is connected to the other end of the heat generation resistor 147.

The ceramic element 12 has a structure in which the element heater 128, the insulating cover layer 126, the auxiliary electrode member 127, the ceramic layer 122, the discharge electrode member 124, the insulating cover layer 125, and the ceramic layer 121 are stacked on the ceramic layer 123 in this order as viewed from the ceramic layer 123 side. Notably, as shown in FIG. 6, the discharge electrode member 124 is disposed in such a manner that a portion of the needle-shaped electrode portion 141 on the forward end side FE and a portion of the lead portion 142 on the back end side BE are not covered by the insulating cover layer 125 and the ceramic layer 121.

Portions of the ceramic layers 121 and 122, which portions are exposed to the outside of the ceramic element 12 and protrude toward the forward end side FE from the forward end of the ceramic holder 43 accommodated in the metallic shell 31, have gas contact surfaces 12a which come into contact with the exhaust gas. A portion of the gas contact surfaces 12a around the needle-shaped electrode portion 141 is a gas contact surface 12b. If the quality of the insulation of the gas contact surface 12b deteriorates, corona discharge by the needle-shaped electrode portion 141 is hindered.

As shown in FIG. 7, the ceramic element 12 includes an electrically conductive trace 131 and electrode pads 132, 133, and 134.

The electrically conductive trace 131 is disposed between the insulating cover layer 126 and the ceramic layer 123 to be located on the back end side BE of the element heater 128. The electrode pads 132, 133, and 134 are disposed on (in close contact with) a surface of the ceramic layer 123, which surface is located on the side opposite the ceramic layer 122. The electrode pads 132, 133, and 134 are disposed on an end portion of the ceramic element 12 on the back end side BE.

The electrically conductive trace 131 is electrically connected to the lead portion 145 of the auxiliary electrode member 127 via a through hole 126a formed in an end portion of the insulating cover layer 126 on the back end side BE. Further, the electrically conductive trace 131 is electrically connected to the electrode pad 132 via a through hole conductor 123a penetrating the ceramic layer 123.

The electrode pad 133 is electrically connected to the lead portion 148 of the element heater 128 via a through hole conductor 123b penetrating the ceramic layer 123. The electrode pad 134 is electrically connected to the lead portion 149 of the element heater 128 via a through hole conductor 123c penetrating the ceramic layer 123.

An end portion of the discharge electrode member 124 on the back end side BE is in contact with the metallic terminal 106. The electrode pad 132 is in contact with the metallic terminal 107. The electrode pad 133 is in contact with the metallic terminal 108. The electrode pad 134 is in contact with the metallic terminal 109.

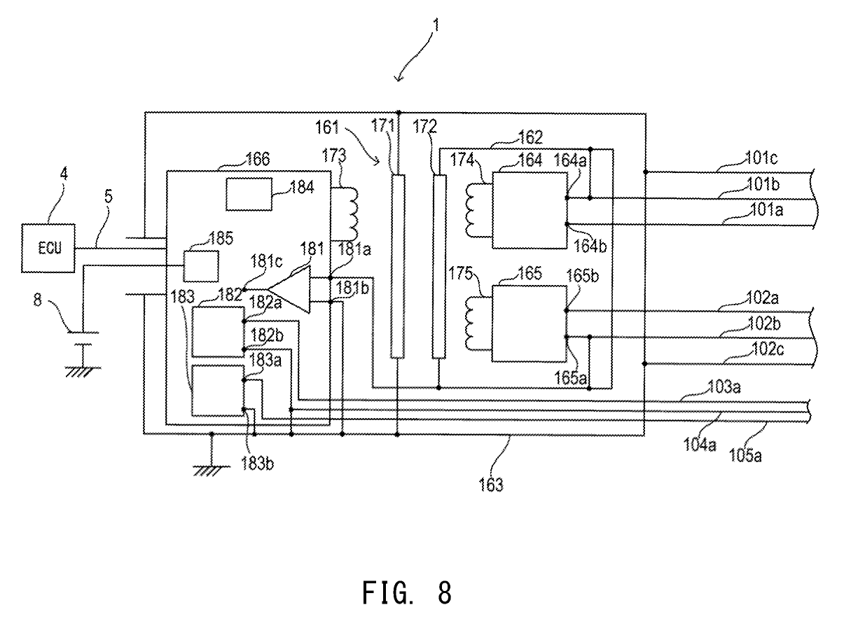

As shown in FIG. 8, the sensor control apparatus 1 includes an isolation transformer 161, an inner circuit case 162, an outer circuit case 163, an ion source power supply circuit 164, an auxiliary electrode power supply circuit 165, and a measurement control section 166.

The isolation transformer 161 has a primary core 171, a secondary core 172, a primary coil 173, and secondary coils

174 and 175. The primary coil 173 is wound around the primary core 171. Opposite ends of the primary coil 173 are connected to the measurement control section 166. The secondary coils 174 and 175 are wound around the secondary core 172. Opposite ends of the secondary coil 174 are connected to the ion source power supply circuit 164. Opposite ends of the secondary coil 175 are connected to the auxiliary electrode power supply circuit 165.

The inner circuit case 162 is a conductor which surrounds the ion source power supply circuit 164 and the auxiliary electrode power supply circuit 165. The inner circuit case 162 is connected to the secondary core 172, the inside outer conductor 101b, and the inside outer conductor 102b.

The outer circuit case 163 is a conductor which surrounds the inner circuit case 162 and the measurement control section 166. The outer circuit case 163 is grounded. Also, the outer circuit case 163 is connected to the primary core 171, the outside outer conductor 101c, and the outside outer conductor 102c.

The ion source power supply circuit 164 outputs a high voltage which is generated between the opposite ends of the secondary coil 174 as a result of the flow of current through the primary coil 173. The ion source power supply circuit 164 has output terminals 164a and 164b. The output terminal 164a is connected to the inside outer conductor 101b. The output terminal 164b is connected to the lead wire 101a. Notably, the potential of the output terminal 164b is higher than the potential of the output terminal 164a.

The auxiliary electrode power supply circuit 165 outputs high voltage which is generated between the opposite ends of the secondary coil 175 as a result of the flow of current through the primary coil 173. The auxiliary electrode power supply circuit 165 has output terminals 165a and 165b. The output terminal 165a is connected to the inside outer conductor 102b. The output terminal 165b is connected to the lead wire 102a. Notably, the potential of the output terminal 165b is higher than the potential of the output terminal 165a.

The measurement control section 166 includes a current detection circuit 181, heater energization circuits 182 and 183, a microcomputer 184, and a regulator power supply 185.

The current detection circuit 181 has input terminals 181a and 181b and an output terminal 181c. The input terminal 181a is connected to the inner circuit case 162. The input terminal 181b is connected to the outer circuit case 163. The current detection circuit 181 detects the current flowing between the input terminals 181a and 181b and outputs a signal representing the detected current from the output terminal 181c.

The heater energization circuit 182 has output terminals 182a and 182b. The output terminal 182a is connected to the lead wire 103a. The output terminal 182b is connected to the outer circuit case 163. In accordance with an instruction from the microcomputer 184, the heater energization circuit 182 generates a PWM control voltage between the output terminal 182a and the output terminal 182b so as to output a PWM signal to the element heater 128, thereby controlling the temperature of the element heater 128. PWM is an abbreviation for Pulse Width Modulation.

The heater energization circuit 183 has output terminals 183a and 183b. The output terminal 183a is connected to the lead wire 105a. The output terminal 183b is connected to the outer circuit case 163 and to the lead wire 104a. In accordance with an instruction from the microcomputer 184, the heater energization circuit 183 generates a previously set heater energization voltage between the output terminal 183a and the output terminal 183b so as to cause the heat generation resistor 111 to generate heat.

The microcomputer 184 includes a CPU, a ROM, a RAM, a signal input output section, etc. The various functions of the microcomputer are realized by a program which is stored in a non-transitory tangible recording medium and executed by the CPU. In this example, the ROM corresponds to a non-transitory tangible recording medium storing the program. Also, a method corresponding to the program is performed as a result of execution of this program. Notably, some or all of the functions of the CPU may be realized by hardware; for example, by a single IC or a plurality of ICs.

The regulator power supply 185 receives a voltage from a battery 8 disposed outside the sensor control apparatus 1 and generates a voltage for operating the sensor control apparatus 1.

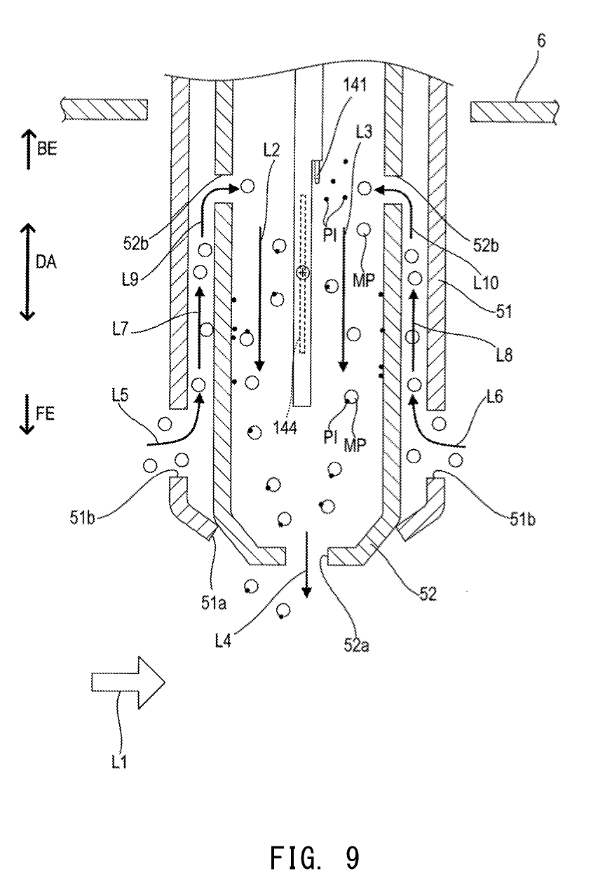

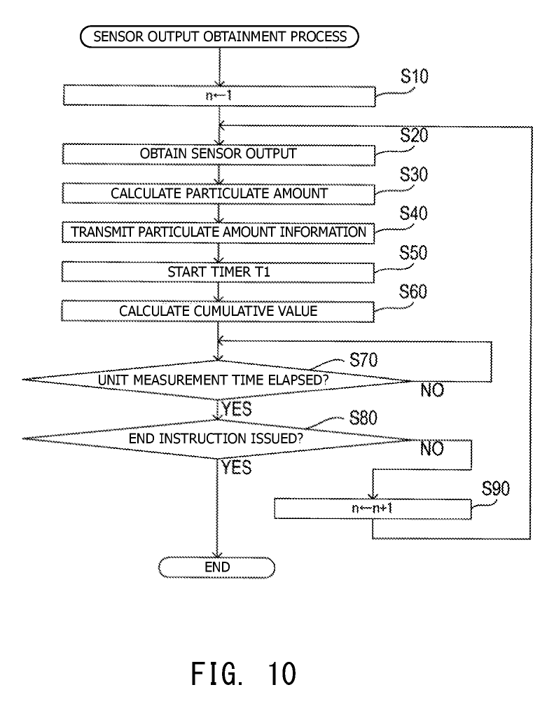

As shown in FIG. 9, the outer protector 51 has an opening 51a formed in its end portion on the forward end side FE. Also, the outer protector 51 has a plurality of gas intake openings 51b formed in a portion of its circumferential wall, which portion is located on the forward end side FE. The inner protector 52 is disposed such that an end portion of the inner protector 52 on the forward end side FE protrudes toward the forward end side FE from the opening 51a of the outer protector 51.

The inner protector 52 has a gas discharge opening 52a formed in its end portion on the forward end side FE. Also, the inner protector 52 has a plurality of gas introduction openings 52b formed in its circumferential wall such that the gas introduction openings 52b are located on the back end side BE with respect to the gas intake openings 51b of the outer protector 51.

When the exhaust gas flows inside the exhaust pipe 6 as indicated by arrow L1, the flow velocity of the exhaust gas increases in a region outside the gas discharge opening 52a of the inner protector 52, and a negative pressure is generated in the vicinity of the gas discharge opening 52a.

Due to this negative pressure, the exhaust gas within the inner protector 52 is discharged to the outside of the inner protector 52 through the gas discharge opening 52a as indicated by arrows L2, L3, and L4. As a result, the exhaust gas present in the vicinity of the gas intake openings 51b of the outer protector 51 is drawn into the internal space of the outer protector 51 through the gas intake openings 51b as indicated by arrows L5 and L6. Further, the exhaust gas drawn into the internal space of the outer protector 51 flows into the internal space of the inner protector 52 through the gas introduction openings 52b as indicated by arrows L7, L8, L9, and L10.

When a high voltage (e.g., 1 to 2 kV) is applied to the needle-shaped electrode portion 141 of the discharge electrode member 124 by the ion source power supply circuit 164, corona discharge occurs between the needle-shaped electrode portion 141 and the inner protector 52. As a result of this corona discharge, positive ions PI are generated around the needle-shaped electrode portion 141.

Since the exhaust gas flows into the internal space of the inner protector 52 from the gas introduction openings 52b, a flow of the exhaust gas from the back end side BE toward the forward end side FE occurs within the inner protector 52. As a result, the positive ions PI generated around the needle-shaped electrode portion 141 adhere to particulates MP contained in the exhaust gas and electrify the particulates MP, whereby electrified particulates are produced.

Also, a previously set voltage (e.g., 100 to 200 V) is applied to the auxiliary electrode portion 144 of the auxiliary electrode member 127 by the auxiliary electrode power supply circuit 165. As a result, floating positive ions PI which have failed to adhere to the particulates MP contained in the exhaust gas move in a direction away from the auxiliary electrode portion 144 due to repulsive forces acting between the floating positive ions PI and the auxiliary electrode portion 144. The positive ions PI moving in the direction away from the auxiliary electrode portion 144 are trapped by the inner wall of the inner protector 52 which serves as a negative pole. Meanwhile, since the particulates electrified as a result of adhesion of the positive ions PI thereto are greater in mass than the positive ions PI, the influence of the repulsive force acting between the electrified particulates and the auxiliary electrode portion 144 is small. Therefore, the electrified particulates are discharged from the gas discharge opening 52a with the flow of the exhaust gas.

Notably, the inner metallic member 21 and the outer metallic member 22 are insulated from each other by the insulating spacers 23 and 24. Namely, the outer metallic member 22 is grounded through the outside outer conductors 101c and 102c, and the inner metallic member 21 is held in the exhaust pipe 6 in a state in which the inner metallic member 21 is insulated from the outer metallic member 22 held at ground potential.

When current corresponding to the flow of the positive ions PI discharged to the outside of the particulate sensor 2 is defined as the leakage current I_{esc} and current corresponding to the flow of the positive ions PI trapped by the inner metallic member 21 is defined as the trapped current Iₜᵣₚ, a relation represented by the following equation (1) holds.

Iᵢₙ=I_{dc}+Iₜᵣₚ+I_{esc} (1)

The discharge current I_{dc} and the trapped current Iₜᵣₚ flow into the inner metallic member 21, and the input current Iᵢₙ is maintained at a fixed value. The input current Iᵢₙ generates the positive ions PI by means of corona discharge.

Therefore, as shown in the following equation (2), the leakage current I_{esc} can be calculated from the difference between the input current Iᵢₙ and the sum of the discharge current I_{dc} and the trapped current Iₜᵣₚ.

I_{esc}=Iᵢₙ−(I_{dc}+Iₜᵣₚ) (2)

As understood from the above equation (2), the current flowing through the inner metallic member 21 is smaller than the input current Iᵢₙ by the leakage current I_{esc}. Therefore, the potential of the inner metallic member 21 decreases (i.e., the reference potential of the inner metallic member 21 becomes lower than the reference potential of the outer metallic member 22), and a compensation current I_{c} which compensates the potential drop flows from the current detection circuit 181 to the inner metallic member 21 through the inside outer conductor 102b. This compensation current I_{c} corresponds to the leakage current I_{esc}. In other words, the compensation current I_{c} (or the leakage current I_{esc}) corresponds to the signal current which flows in accordance with the amount of the electrified particulates. The current detection circuit 181 measures the value of the compensation current I_{c} and treats the measured value of the compensation current I_{c} as a measured value of the leakage current I_{esc}. The current detection circuit 181 outputs to the microcomputer 184 a leakage current signal representing the measured value of the leakage current I_{esc}.

The microcomputer 184 determines the measured value of the leakage current I_{esc} based on the leakage current signal input from the current detection circuit 181, and calculates the amount of particulates in the exhaust gas using a map or a computation expression which shows the relation between the measured value of the leakage current I_{esc} and the amount of particulates in the exhaust gas. The amount of particulates in the exhaust gas can be evaluated, for example, as an amount determined based on the surface area of the particulates or an amount determined based on the mass of the particulates. Alternatively, the amount of particulates in the exhaust gas can be evaluated as an amount determined based on the number of particulates per unit volume of the exhaust gas.

Also, the microcomputer 184 causes the element heater 128 and the heat generation resistor 111 to generate heat, thereby burning and removing the particulates adhering to the needle-shaped electrode portion 141 of the discharge electrode member 124 and the particulates adhering to the gas contact surface 23a of the insulating spacer 23.

Also, the microcomputer 184 executes a sensor output obtaining process and an anomaly detection process.

First, the steps of the sensor output obtaining process will be described. The sensor output obtaining process is started when a start instruction is issued in the anomaly detection process.

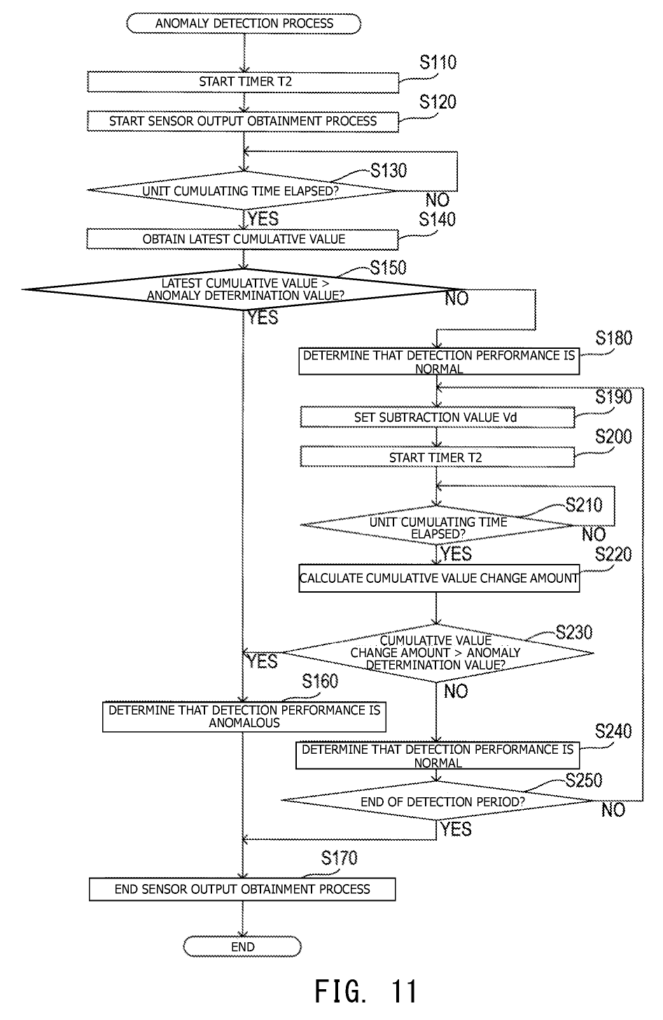

FIG. 10 shows the sensor output obtaining process. As shown in FIG. 10, in S10, the CPU of the microcomputer 184 first stores 1 in a storage area provided in the RAM for storing a value indicating the number of obtainment times n (hereinafter referred to as the “obtainment count indication value n”). In S20, the CPU obtains the leakage current signal output from the current detection circuit 181 (hereinafter referred to as the “sensor output”). In S30 subsequent thereto, the CPU calculates the amount of particulates in the exhaust gas based on the sensor output obtained in S20. In S40, the CPU transmits particular amount information to the engine ECU 4. The particular amount information represents the amount of particulates calculated in S30.

In S50, the CPU starts a timer T1 provided in the RAM. This timer T1 is a timer whose count value is incremented at intervals of, for example, 1 ms. When the timer T1 is started, its count value is incremented from 0 (namely, one is added to the count value). In S60, the CPU calculates a cumulative value Vc(n) of the obtained sensor output. Specifically, the CPU stores, as the cumulative value Vc(n), a value obtained by adding together a value stored in the RAM as a cumulative value Vc(n−1) and a current value indicated by the sensor output obtained in S20.

In S70, the CPU determines whether or not a previously set unit measurement time (200 ms in the present embodiment) has elapsed. Specifically, the CPU determines whether or not the count value of the timer T1 is equal to or greater than a value corresponding to the unit measurement time.

In the case where the unit measurement time has not yet elapsed, the CPU waits until the unit measurement time has elapsed by repeating the process of S70. In the case where the unit measurement time has elapsed, in S80, the CPU determines whether or not an end instruction has been issued in the anomaly detection process. In the case where the end instruction has not yet been issued in the anomaly detection process, in S90, the CPU adds one to the value stored in the storage area for the obtainment count indication value n, stores the resultant value in the storage area for the obtainment count indication value n, and proceeds to S20. Meanwhile, in the case where the end instruction has been issued in the anomaly detection process, the CPU ends the sensor output obtaining process.

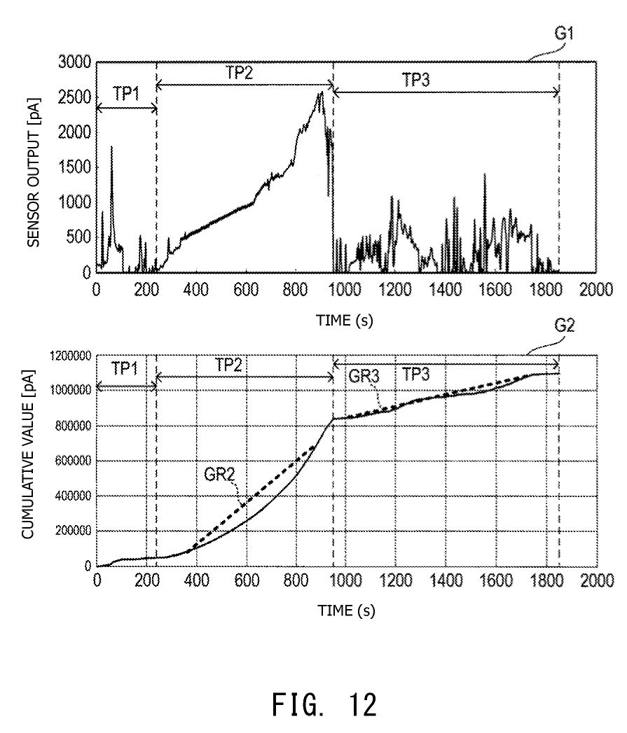

Next, the steps of the anomaly detection process will be described. This anomaly detection process is a process which is started immediately after a key switch of the vehicle is turned on and the microcomputer 184 starts its operation. FIG. 11 shows the anomaly detection process. As shown in FIG. 11, in S110, the CPU of the microcomputer 184 first starts a timer T2 provided in the RAM. This timer T2 is a timer whose count value is incremented at intervals of, for example, 1 sec. When the timer T2 is started, its count value is incremented from 0.

In S120, the CPU issues an instruction for starting the sensor output obtaining process. In S130, the CPU determines whether or not a previously set unit cumulating time (200 seconds in the present embodiment) has elapsed. Specifically, the CPU determines whether or not the count value of the timer T2 is equal to or greater than a value corresponding to the unit cumulating time.

In the case where the unit cumulating time has not yet elapsed, the CPU waits until the unit cumulating time has elapsed by repeating the process of S130. In the case where the unit cumulating time has elapsed, in S140, the CPU obtains the latest cumulative value Vc(n) stored in the RAM. Subsequently, in S150, the CPU determines whether or not the latest cumulative value Vc(n) obtained in S140 is greater than a previously set anomaly determination value. In the case where the cumulative value Vc(n) is greater than the anomaly determination value, in S160, the CPU determines that the detection performance of the particulate sensor 2 is anomalous. Further, the CPU issues an instruction for ending the sensor output obtaining process in S170 and ends the anomaly detection process.

Meanwhile, in the case where the cumulative value Vc(n) is equal to or less than the anomaly determination value, in S180, the CPU determines that the detection performance of the particulate sensor 2 is normal. Subsequently, in S190, the CPU sets a subtraction value Vd. Specifically, the CPU stores the latest cumulative value Vc(n), obtained in S140 or S220, in a storage area provided in the RAM for storing the subtraction value Vd. In S200, the CPU starts the timer T2. Subsequently, in S210, the CPU determines whether or not the unit cumulating time has elapsed in the same manner as in S130.

In the case where the unit cumulating time has not yet elapsed, the CPU waits until the unit cumulating time has elapsed by repeating the process of S210. In the case where the unit cumulating time has elapsed, in S220, the CPU calculates a cumulative value change amount ΔVc. Specifically, the CPU obtains the latest cumulative value Vc(n) stored in the RAM and stores, in a storage area provided in the RAM for the cumulative value change amount ΔVc, a value obtained by subtracting the subtraction value Vd set in S190 from the latest cumulative value Vc(n).

Subsequently, in S230, the CPU determines whether or not the cumulative value change amount ΔVc is greater than an anomaly determination value. In the case where the cumulative value change amount ΔVc is greater than the anomaly determination value, the CPU proceeds to S160. Meanwhile, in the case where the cumulative value change amount ΔVc is equal to or less than the anomaly determination value, in S240, the CPU determines that the detection performance of the particulate sensor 2 is normal. Further, in S250, the CPU determines whether or not the detection period has ended. The detection period is, for example, a period during which the amount of particulates contained in the exhaust gas is calculated or a predetermined period for determining whether not the DPF is anomalous.

In the case where the detection period has not ended, the CPU proceeds to S190. Meanwhile, in the case where the detection period has ended, the CPU proceeds to S170.

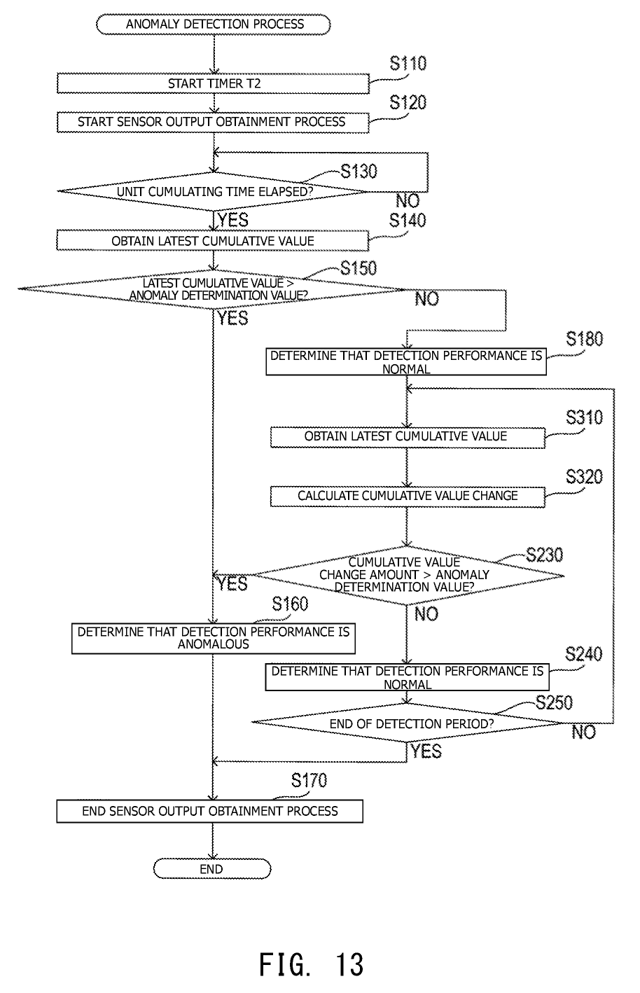

Graph G1 of FIG. 12 shows a time-course change in the current value detected by the current detection circuit 181 during a certain measurement period. Graph G2 of FIG. 12 shows a time-course change in the cumulative value of the current value detected by the current detection circuit 181 during the same measurement period as graph G1.

As shown in graph G1, in a period TP1 from 0 sec to 200 sec, the value of the sensor output exhibits repeated sharp increases and decreases, and the particulate sensor 2 detects the amount of particulates contained in the exhaust gas. Meanwhile, in a period TP2 from 200 sec to 960 sec, the value of the sensor output increases steadily, and the particulate sensor 2 does not detect the amount of particulates contained in the exhaust gas. In a period TP3 from 960 sec to 1850 sec, the value of the sensor output exhibits repeated sharp increases and decreases as in the period TP1, and the particulate sensor 2 detects the amount of particulates. Conceivably, the reason why the detection performance of the particulate sensor 2 became anomalous in the period TP2 and normal in the period TP3 is that an anomaly was caused by water adhering to the gas contact surface 23a. Namely, conceivably, water had adhered to the gas contact surface 23a in the period TP2, and the water adhered to the gas contact surface 23a had evaporated in the period TP3.

As shown in graph G2, the gradient GR2 of the cumulative value in the period TP2 is about 5 times the gradient GR3 of the cumulative value in the period TP3. Therefore, the determination as to whether the detection performance of the particulate sensor 2 is normal or anomalous can be made based on the magnitude of the cumulative value change amount.

The sensor control apparatus 1 configured as described above controls the particulate sensor 2 which is attached to the exhaust pipe 6 of the diesel engine 3 and detects the amount of particulates contained in the exhaust gas within the exhaust pipe 6.

The particulate sensor 2 includes the inner metallic member 21, the ceramic element 12, and the insulating spacer 23. Hereinafter, the inner metallic member 21 and the ceramic element 12 are collectively referred to as the detection section.

The inner metallic member 21 and the ceramic element 12 (i.e., the detection section) are configured to electrify particulates contained in the exhaust gas flowing thereinto, thereby producing electrified particulates.

The insulating spacer 23 has the gas contact surface 23a which comes into contact with the exhaust gas. If particulates adhere to the gas contact surface 23a, the detection performance of the detection section deteriorates.

Every time the unit measurement time elapses, the sensor control apparatus 1 calculates the amount of particulates based on the compensation current I_{c} which flows due to the electrified particulates. The sensor control apparatus 1 calculates the cumulative value Vc(n) of the compensation current I_{c}. The sensor control apparatus 1 determines whether or not the cumulative value change amount ΔVc in the unit cumulating time set to be longer than the unit measurement time is greater than the anomaly determination value. In the case where the cumulative value change amount ΔVc is greater than the anomaly determination value, the sensor control apparatus 1 determines that the detection performance of the detection section is anomalous.

In the case where condensed water generated within the exhaust pipe 6 flows inside the exhaust pipe 6 and adheres to the insulating spacer 23 of the particulate sensor 2, thereby lowering the quality of the insulation of the insulating spacer 23, the sensor control apparatus 1 configured as described above can determine that the detection performance of the detection section is anomalous. This is because of the following reason. In the case where the quality of the insulation of the insulating spacer 23 is lowered as a result of adhesion of condensed water, the compensation current I_{c} increases, as compared with the case where the quality of the insulation of the insulating spacer 23 is not lowered. Further, the cumulative value change amount ΔVc in the unit cumulating time becomes greater than the anomaly determination value. Thus, the sensor control apparatus 1 can detect temporary deterioration of the detection performance of the particulate sensor 2.

Also, the sensor control apparatus 1 determines whether or not the cumulative value change amount ΔVc is greater than the anomaly determination value every time the unit cumulating time elapses. Thus, the sensor control apparatus 1 can reduce the computation load for determining whether or not the detection performance of the particulate sensor 2 is anomalous, as compared with the case where the determination is made every time the unit measurement time elapses.

The particulate sensor 2 includes the inner metallic member 21 and the outer metallic member 22, and the insulating spacer 23 is disposed between the inner metallic member 21 and the outer metallic member 22 so as to electrically insulate the inner metallic member 21 and the outer metallic member 22 from each other. The inner metallic member 21 has the gas introduction pipe 32 through which the exhaust gas is introduced into the internal space of the inner metallic member 21. The inner metallic member 21 is maintained at a potential different from that of the exhaust pipe 6 and is contained in the detection section. The outer metallic member 22 surrounds the circumference of the inner metallic member 21, and is attached to the exhaust pipe 6, so that the outer metallic member 22 is electrically connected to the exhaust pipe 6.

In the case where condensed water adheres to the gas contact surface 23a of the insulating spacer 23 disposed between the inner metallic member 21 and the outer metallic member 22, thereby lowering the insulating performance of the insulating spacer 23 between the inner metallic member 21 and the outer metallic member 22, the sensor control apparatus 1 configured as described above can determine that the detection performance of the particulate sensor 2 is anomalous. Thus, the sensor control apparatus 1 can detect temporary deterioration of the detection performance of the particulate sensor 2.

In the above-described embodiment, the sensor control apparatus 1 corresponds to the particulate detection apparatus; the diesel engine 3 corresponds to the internal combustion engine; the inner metallic member 21 and the ceramic element 12 correspond to the detection section; and the insulating spacer 23 and the ceramic layers 121 and 122 correspond to the insulating member.

Also, the compensation current I_{c} corresponds to the signal current; S20, S30, S50, S70, and S80 correspond to a process of the calculation section; S60 corresponds to a process of the cumulating section; and S110 to S160 and S180 to S240 correspond to a process of the anomaly determination section.

### Second Embodiment

A second embodiment of the present disclosure will now be described with reference to the drawings. Notably, in the second embodiment, portions different from those of the first embodiment will be described. Common constituent elements are denoted by the same reference numerals.

A sensor control apparatus 1 of the second embodiment differs from that of the first embodiment in the point that the sensor control apparatus 1 of the second embodiment executes a changed anomaly detection process.

The anomaly detection process of the second embodiment differs from that of the first embodiment in the point that processes of S310 to S320 are executed in place of the processes of S190 to S220.

Namely, as shown in FIG. 13, after completing the process of S180, in S310, the CPU obtains the latest cumulative value Vc(n) stored in the RAM. Subsequently, in S320, the CPU calculates the cumulative value change amount ΔVc. Specifically, the CPU obtains the cumulative value Vc(n-m) stored in the RAM and stores, in the storage area provided in the RAM for the cumulative value change amount ΔVc, a value obtained by subtracting the cumulative value Vc(n-m) from the cumulative value Vc(n) obtained in S310. The constant “m” represents the number of sensor outputs obtained during the unit cumulating time. The constant “m” is a previously set value and can be calculated by dividing the unit cumulating time by the unit measurement time.

After completing the process of S320, the CPU proceeds to S230. In the case where the CPU determines in S250 that the detection period has not ended, the CPU proceeds to S310.

The sensor control apparatus 1 configured as described above determines whether or not the cumulative value change amount ΔVc is greater than the anomaly determination value. This determination is made every time the unit measurement time elapses, after the unit cumulating time has elapsed for the first time after having started calculation of the cumulative value Vc(n). Therefore, the sensor control apparatus 1 can detect an anomaly of the detection performance of the particulate sensor 2 earlier as compared with the case where the determination is made every time the unit cumulating time elapses.

In the above-described embodiment, S110 to S160, S180, S310 to S320, S230, and S240 correspond to a process of the anomaly determination section.

Various embodiments have been described above, but the present invention is not limited to the above embodiments and can be embodied in various other forms within the technical scope of the present invention.

For example, in the above-described embodiments, the anomaly determination value is a fixed value. However, the anomaly determination value may be changed in accordance with, for example, the state of the vehicle.

In the above-described embodiments, the cumulative value of the current value represented by the sensor output is calculated. However, the embodiments may be modified to obtain, as a converted value, a value converted from the sensor output and representing the amount of particulates and to calculate the cumulative value of the converted value.

Also, the function of one constituent element in the above embodiments may be distributed to a plurality of constituent elements, or the functions of a plurality of constituent elements may be realized by one constituent element. Part of the configurations of the above embodiments may be omitted. Also, at least part of the configuration of each of the above embodiments may be added to or partially replace the configurations of other embodiments.

The present disclosure may be realized in various forms other than the above-described sensor control apparatus 1. For example, the present disclosure may be realized as a system including the sensor control apparatus 1 as a constituent element, a program for causing a computer to function as the sensor control apparatus 1, a medium on which the program is recorded, and an anomaly detection method.

The invention has been described in detail with reference to the above embodiments. However, the invention should not be construed as being limited thereto. It should further be apparent to those skilled in the art that various changes in form and detail of the invention as shown and described above may be made. It is intended that such changes be included within the spirit and scope of the claims appended hereto.

This application is based on Japanese Patent Application No. JP 2018-056408 filed Mar. 23, 2018, incorporated herein by reference in its entirety.

What is claimed is:

1. A particulate detection apparatus for controlling a particulate sensor which is attached to an exhaust pipe of an internal combustion engine and which detects an amount of particulates contained in exhaust gas within the exhaust pipe,
wherein the particulate sensor comprises:
a detection section configured to electrify particulates contained in exhaust gas flowing into an internal space of the detection section, thereby generating electrified particulates; and
an insulating member having a gas contact surface which comes into contact with the exhaust gas, the insulating member being configured such that the detection performance of the detection section deteriorates when particulates adhere to the gas contact surface,
wherein the particulate detection apparatus comprises:
a calculation section configured to calculate, every time a previously set unit measurement time elapses, the value of a signal current flowing due to the electrified particulates or a converted value which is obtained from the signal current and which represents the amount of the particulates;
a cumulating section configured to cumulate the value of the signal current or converted value thereof to thereby calculate a cumulative value; and
an anomaly determination section configured to determine whether or not an amount of change in the cumulative value in a unit cumulating time set to be longer than the unit measurement time is greater than a previously set anomaly determination value and to determine that the detection performance of the detection section is anomalous when the amount of change is greater than the anomaly determination value.

2. The particulate detection apparatus as claimed in claim 1, wherein, every time the unit cumulating time elapses, the anomaly determination section determines whether or not an updated amount of change in the unit cumulating time is greater than the anomaly determination value.

3. The particulate detection apparatus as claimed in claim 1, wherein, after the unit cumulating time has elapsed for the first time after the cumulating section has started calculating the cumulative value, every time the unit measurement time elapses, the anomaly determination section updates the unit cumulating time, and determines whether or not the amount of change in the updated unit cumulating time is greater than the anomaly determination value.

4. The particulate detection apparatus as claimed in claim 1, wherein the particulate sensor comprises:
an inner metallic member which has a gas introduction pipe for introducing exhaust gas into an internal space of the inner metallic member, which inner metallic member is maintained at a potential different from that of the exhaust pipe, and which is contained in the detection section; and
an outer metallic member which surrounds the circumference of the inner metallic member and which is attached to the exhaust pipe so as to be electrically connected to the exhaust pipe,
wherein the insulating member is disposed between the inner metallic member and the outer metallic member and electrically insulates the inner metallic member and the outer metallic member from each other.
